(19) United States
(12) Patent Application Publication
(10) Pub. No.: US 2004/0203416 A1
(43) Pub. Date: Oct. 14, 2004

(54) Mobile communications terminal, mobile communications system and mobile communications data rate display method

(75) Inventors: Yoko Hata, Yokohama (JP); Yasuhito Maejima, Kawasaki (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/315,547

(22) Filed: Dec. 10, 2002

(30) Foreign Application Priority Data
Jul. 16, 2002 (JP) 2002-207171

(51) Int. Cl. H04B 1/38; H04Q 7/20

(52) U.S. Cl. 455/67.7; 455/566; 370/232; 455/452.1

(57) ABSTRACT

A mobile wireless communications system includes mobile terminals and a base station for wireless communications. A base station sends a pilot signal to the mobile terminals. The pilot signal received by the mobile terminal is correlated to a data rate according to predetermined rules. The correlated data rate is further correlated to a display symbol. The mobile terminal specifies the data rate correlated to the pilot signal received and causes a display device of the mobile terminal to display the display symbol correlated to the specified data rate for its user to view.

### BACKGROUND OF THE INVENTION

1. Field of the Invention

The present invention relates to mobile communications systems.

2. Description of Related Art

In recent years, there has been an increased demand for large capacity data communications, such as videos and music, using not only personal computers but also cellular phones and PDAs (personal digital (data) assistants) and other mobile terminals. In such data communications, the data rate that indicates the amount of data transmitted per unit time is an important factor in ascertaining the time and cost required for data communication.

However, in mobile communications systems, the data rate varies depending on a mobile terminal's distance from an access point and the moving speed of the mobile terminal.

Consequently, if current data rate can be presented to users before they commence communication, the users can choose not to communicate a large amount of data when the data rate is slow. Through this, communications carriers can reduce deteriorating line efficiency caused by users occupying a line for a long period of time. On the user's side, he or she can estimate the time required for the communication processing currently under way, as well as the communications cost.

There are examples in the past of displaying data rates and data transmission time in the field of wired communications. Further, in the field of mobile communications, a technique has been proposed to display on a mobile terminal uplink data rate from the mobile terminal to an access point.

As our lifestyles become increasingly diversified, data communicated by users range in various fields and types. In addition, the type of data communicated often varies by user, which often means that different data rates are required for different users. However, the prior art does not display data rates required by users based on standards that accommodate individual users.

### SUMMARY OF THE INVENTION

In view of the problems described above, the present invention provides a system to display data rates based on standards that accommodate individual users.

The data rate of mobile communications systems varies depending on a mobile terminal's distance from an access point and the moving speed of the mobile terminal, as described above. Consequently, a data rate deemed by a user to be optimal for data communication may experience deterioration during the communication. In view of this, one aspect of the present invention is to display data rates that reflect changing tendencies in the data rates. It is noted that the mobile terminal may mean a mobile communication terminal, an access terminal for wireless or radio communication and the like. Also, the access point may mean an access point for wireless communication, a base station for wireless or radio communication and the like.

In mobile communications, there are instances where communications carriers wish to restrain or rouse communications by users due to such reasons as traffic congestion on the network. In view of this, it is another aspect of the present invention to have an access point determine the data rates and to display the determined data rates to users.

In order to solve the problems described above, in accordance with an embodiment of the present invention, a pilot signal sent by an access point and received by a mobile terminal is correlated to a data rate according to predetermined rules. The correlated data rate is further correlated to a display symbol. The mobile terminal specifies the data rate correlated to the pilot signal received and causes a display device of the mobile terminal to display the display symbol correlated to the specified data rate for its user to see.

For example, in accordance with a first embodiment of the present invention, a mobile communications system includes a plurality of mobile terminals and an access point for mobile communications, which are capable of communicating with one another.

Each mobile terminal may include a receiving section that receives a signal from the access point to measure a data rate; a signal processing section that measures data relating to the data rate based on the signal received by the receiving section; a symbol determination section that, according to predetermined rules, specifies a data rate based on the data measured by the signal processing section, categorizes the specified data rate into a rate class, and specifies an image symbol that is determined in advance to correspond to the categorized rate class; and a display section that displays the image symbol specified by the symbol determination section.

The mobile terminal may have a storage section that stores a symbol determination table that stores rate classes, data rate ranges, and image symbols that are correlated to each other in advance. The symbol determination section may categorize the specified data rate into the rate class the specified data rate belongs to based on data stored in the symbol determination table and may specify an image symbol corresponding to the categorized rate class.

In addition, the mobile terminal may also have a user interface section that accepts registration of, and changes to, rate classes in the symbol determination table, as well as registration of, and changes to, image symbols in the symbol determination table.

The access point may also have a communication processing section that sends to the mobile terminal a signal for measuring the data rate.

In the first embodiment of the present invention, due to the fact that the data rate is categorized into the rate class it belongs to and displayed on the display section of the mobile terminal as an image symbol, a user can communicate data after determining the time and cost required for the data communication. Further in the first embodiment of the present invention, due to the fact that the user can freely set rate classes corresponding to data rates represented as image symbols displayed on the mobile terminal, data rates appropriate for the communication data that are to be used by the user can be displayed.

In the present embodiment, a predetermined statistical processing may be performed on data regarding the data rate specified by the mobile terminal and the image symbol displayed may be changed based on the result of the statistical processing.

For example, in the mobile terminal, the symbol determination section can perform a statistical processing to find an increase/decrease tendency value in data regarding the data rate measured by the signal processing section, and if the increase/decrease tendency value obtained through the statistical processing indicates a greater decrease tendency than a predetermined value, an image symbol that corresponds to a rate class one class lower than the image symbol that corresponds to the specified rate is specified, and the newly specified image symbol is displayed on the display section. Through such a configuration, image symbols that correspond to rate classes of data rates that take into account changing tendencies in the data rates can be displayed. Consequently, adequate information can be provided to a user to determine whether the user, who receives data of a particularly large volume that would require a long period of time, should receive the data, thereby improving the user's level of satisfaction.

Furthermore, in accordance with a second embodiment of the present invention, an access point for mobile communications determines a data rate and sends to a mobile terminal a signal that notifies the data rate determined. The mobile terminal receives the signal notifying the data rate and displays on a display device of the mobile terminal a display symbol that corresponds to the signal that notifies the data rate.

For example, the mobile communications system according to the second embodiment of the present invention includes, like the mobile communications system according to the first embodiment, a plurality of mobile terminals and an access point.

Each mobile terminal comprises a receiving section that receives from the access point a signal that includes data that designates a data rate; a symbol determination section that specifies, according to predetermined rules, an image symbol that corresponds to the data rate based on the data that designates the data rate and that is included in the signal received by the receiving section; and a display section that displays the image symbol specified by the symbol determination section.

The access point has a communication processing section that sends to the mobile terminal a signal that contains data that designates the data rate.

In this way, the mobile communications system of the second embodiment of the present invention can display on the mobile terminal the data rate determined by the access point as a symbol for the data rate. Consequently, the access point can determine data rates that take into account traffic on the network, for example, and display the data rates on the mobile terminals in order to restrain or rouse data communications by users.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 schematically shows a mobile communications system in accordance with a first embodiment of the present invention.

FIG. 2 schematically shows a configuration of functions of an access terminal 100 in accordance with the first embodiment of the present invention.

FIG. 3 schematically shows a configuration of functions of an access point 200 in accordance with the first embodiment of the present invention.

FIG. 4 shows a sequence involved in determining a data rate in the mobile communications system according to the first embodiment, when an HDR system is applied to data communications.

FIG. 5 shows an example of a data structure of a data rate determination table 650 of the access terminal 100 to which the present invention is applied.

FIG. 6 shows an example of a data structure of a symbol determination table 600 of the access terminal 100 to which the first embodiment of the present invention is applied.

FIG. 7 shows a sequence of operations by the access terminal 100 to display a symbol corresponding to a data rate, in the mobile communications system according to the first embodiment.

FIG. 8 shows an example of a symbol display screen displayed by a symbol display section 110 of the access terminal 100 to which the first embodiment of the present invention is applied.

FIG. 9 shows an example of a symbol display screen displayed by the symbol display section 110 of the access terminal 100 to which the first embodiment of the present invention is applied.

FIG. 10 shows an example of a symbol display screen displayed by the symbol display section 110 of the access terminal 100 to which the first embodiment of the present invention is applied.

FIG. 11 shows an example of a symbol display screen displayed by the symbol display section 110 of the access terminal 100 to which the first embodiment of the present invention is applied.

FIG. 12 shows a sequence of operations by the access terminal 100 to register and update a symbol definition table and a user-defined table, in the mobile communications system according to the first embodiment of the present invention.

FIG. 13 shows a sequence of operations by an access terminal 100 to display a symbol corresponding to a data rate, in a mobile communications system in accordance with a second embodiment of the present invention.

FIG. 14 shows an example of a symbol display screen displayed by a symbol display section 110 of the access terminal 100 to which the second embodiment of the present invention is applied.

FIG. 15 shows an example of a mock data structure of a symbol determination table 640 stored in a storage section 160 in accordance with a third embodiment the present invention.

FIG. 16 shows a sequence of operations by an access terminal 100 to display a symbol corresponding to a data rate, in a mobile communications system according, to the third embodiment of the present invention.

FIG. 17 shows an example of a symbol display screen displayed by a symbol display section 110 of the access terminal 100 to which the third embodiment of the present invention is applied.

FIG. 18 shows an example of a data structure of a symbol determination table 800 stored in a storage section 160 of each access terminal 100 in the fourth embodiment.

### PREFERRED EMBODIMENTS OF THE INVENTION

Preferred embodiments of the present invention will be described below with reference to the accompanying drawings. First, a first embodiment of the present invention will be described.

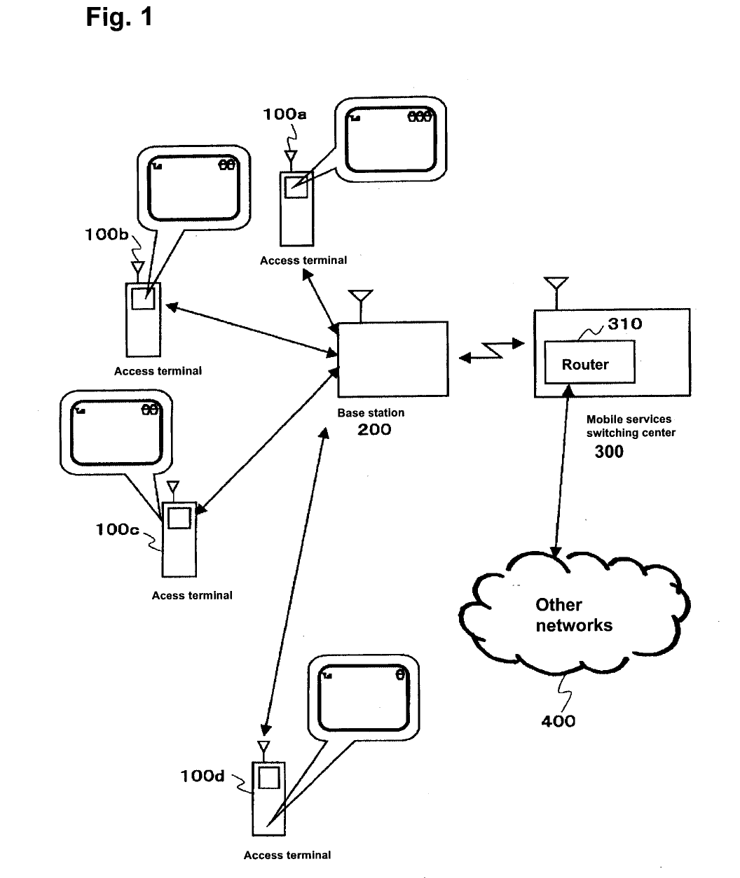

FIG. 1 schematically shows a mobile communications system in accordance with the first embodiment of the present invention.

As shown in FIG. 1, the mobile communications system of the first embodiment includes access terminals 100a, 100b, 100c and 100d (hereinafter, these may simply be called “access terminals 100”), an access point 200, which may be an access point or base station for wireless mobile communication, and a mobile service switching center (hereafter referred to as a “switching station”) 300, which may be a switching station for wireless mobile communications.

Each of the access terminals 100 performs wireless data communications with the access point 200 and has a function to display data on data rate, which indicates the amount of data transmitted per unit time.

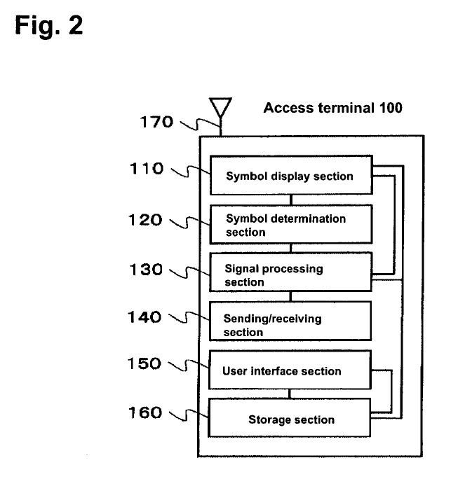

FIG. 2 shows a configuration of functions of each of the access terminals 100.

As FIG. 2 shows, each of the access terminals 100 has a symbol display section 110, a symbol determination section 120, a signal processing section 130, a sending/receiving section 140, a user interface section 150, a storage section 160, and an antenna 170.

The symbol display section 110 displays symbols correlated to data rates, content of communication data and other data.

The storage section 160 stores a program that operates the access terminal 100, a symbol determination table 600 that stores data on data rates correlated to symbols to be displayed, and a data rate determination table 650 that stores data on each pilot signal sent from the access point 200 correlated to data on a data rate requested of the access point 200. Data structures of the symbol determination table 600 and the data rate determination table 650 will be described in detail later.

The sending/receiving section 140 receives pilot signals that determine data rates. The sending/receiving section 140 in addition sends data on requested data rates to the access point 200. Furthermore, the sending/receiving section 140 communicates data with the access point 200.

When the signal processing section 130 receives a pilot signal received by the sending/receiving section 140, it measures from the pilot signal the data on a data rate, and sends the data on the data rate measured to the symbol determination section 120. The signal processing section 130 receives from the symbol determination section 120 data on the data rate requested, which will be described later, and have the sending/receiving section 140 send the data on data rate requested to the access point 200.

The symbol determination section 120 determines a requested data rate value based on the data on the data rate measured by the signal processing section 130 and on the data in the data rate determination table 650 stored in the storage section 160, and sends the requested data rate value that has been determined to the signal processing section 130. Furthermore, the symbol determination section 120 determines a symbol that is to be displayed on the symbol display section 110 based on the data on the data rate measured by the signal processing section 130 and on data stored in the symbol determination table 600 stored in the storage section 160, and causes the display section 110 to display the determined symbol.

In this way, each of the access terminals 100 can determine the data rate at which the access terminal 100 can receive data. In addition, before the access terminal 100 sends the data, the access terminal 100 can have the symbol display section 110 display the symbol correlated to the determined data rate.

Cellular telephones, PDAs with mobile communication functions or PDAs that are connectable to cellular telephones, or car navigation terminal devices may be used as the access terminals 100, for example.

The access point 200 relays any of the access terminals 100 to the switching station 300.

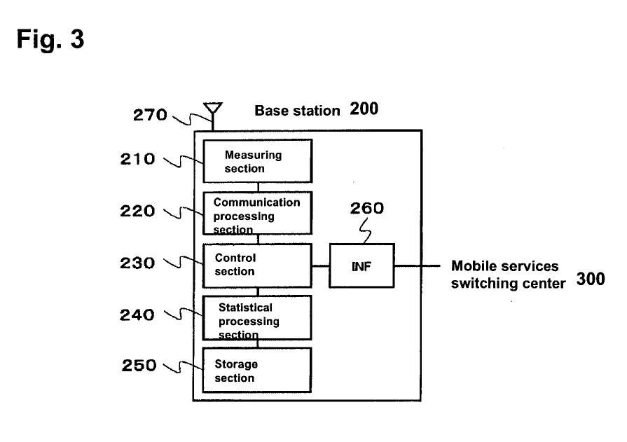

FIG. 3 shows a configuration of functions of the access point 200.

As the figure shows, the access point 200 has a measuring section 210 that measures data on data rates of each of the access terminals 100, a communication processing section 220 that communicates data with any of the access terminals 100, a control section 230 that performs various controls within the access point 200, a statistical processing section 240 that performs statistical processing on data on data rates and line efficiency, a storage section 250 that stores communications data and programs to operate the access point 200, an interface (hereinafter called “INF”) section 260 that connects with the switching station 300, and an antenna 270.

The communication processing section 220 sends a pilot signal to the access terminals 100. The communication processing section 220 also receives data on a data rate requested by any of the access terminals 100 that is sent from the sending/receiving section 140 of the corresponding access terminal 100.

The measuring section 210 measures the requested data rate value from the reception data received by the communication processing section 220.

The control section 230 determines the data rate based on the requested data rate value measured by the measuring section 210. In addition, the control section 230 causes the communication processing section 220 to send data requested at the data rate determined to one of the access terminals 100, based on a request from the applicable access terminal 100.

A computer system with a wireless communication function to connect with the access terminals 100 and a communication function to connect with the switching station 300 can be used as the access point 200, for example.

The switching station 300 performs circuit switching in mobile communications. The switching station 300 has a router 310. The router 310 connects any of the access terminals 100 to other networks 400, which can be other mobile communications networks or wired networks. Through this, data relay takes place between the access terminals 100 and the other networks 400.

Next, descriptions are made as to an operation to determine a data rate between one of the access terminals 100 and the access point 200 in the mobile communications system according to the present embodiment, using an example in which an HDR (high data rate) system (e.g., cdma 2000 1×EV−Do) is applied to data communications.

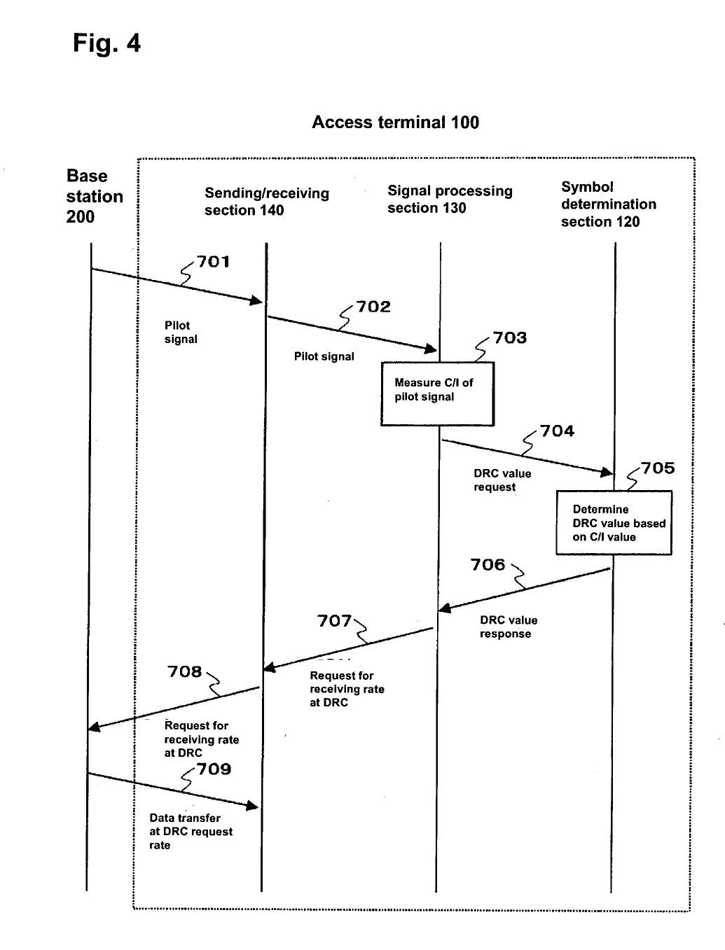

FIG. 4 illustrates the sequence involved in determining a data rate in the mobile communications system according to the first embodiment, when an HDR system is applied to data communications.

In the access point 200, the communication processing section 220 sends a pilot signal to the access terminal 100 (S701).

The sending/receiving section 140 of the access terminal 100 receives the pilot signal and sends the pilot signal to the signal processing section 130 (S702). Upon receiving the pilot signal, the signal processing section 130 measures carrier to interference power ratio (C/I) values of the pilot signal (S703). Next, the signal processing section 130 sends data on a C/I value determined to the symbol determination section 120 (S704).

Upon receiving the data on the C/I value determined from the signal processing section 130, the symbol determination section 120 refers to data in the data rate determination table 650, which will be described later, stored in the storage section 160 and determines a DRC (data rate control) value, which is a value related to a data rate that corresponds to the C/I value determined (S705). The symbol determination section 120 then sends data on the DRC value determined to the signal processing section 130 (S706).

The signal processing section 130 sends the data on the DRC value received from the symbol determination section 120 to the sending/receiving section 140 (S707). The sending/receiving section 140 sends the DRC value data to the access point 200 (S708).

In the access point 200, upon receiving the DRC value data sent to the access point 200, the communication processing section 220 sends the data to the measuring section 210. The measuring section 210 measures a requested data rate value based on the DRC value data received from the communication processing section 220. The control section 230 sends to the access terminal 100 data at a data rate having a requested DRC rate measured (S709).

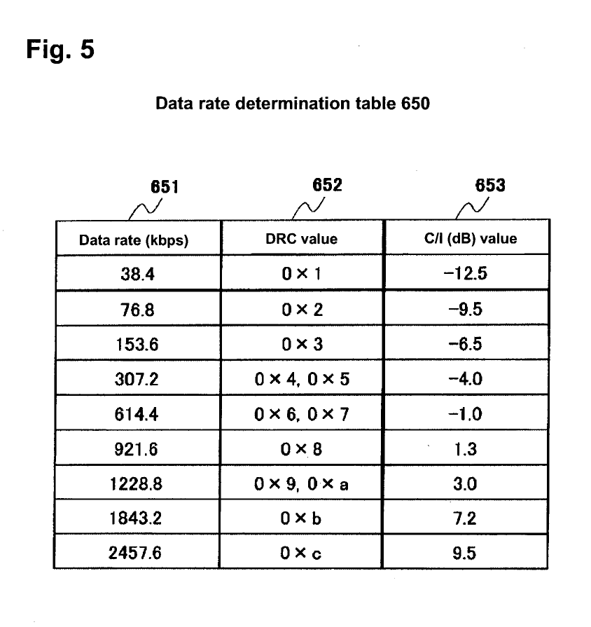

FIG. 5 is an example of a data structure of the data rate determination table 650 that is stored in the storage section 160 of each of the access terminals 100.

As FIG. 5 shows, the data rate determination table 650 has entries 651 to register data rates (kbps), entries 652 to register DRC values, and entries 653 to register C/I (dB) values. Various data in the data rate determination table 650 are stored in advance by the provider of the access terminal 100.

For example, a C/I value “−12.5 (dB),” a data rate “38.4 (kbps),” and a DRC value “0×1” are correlated to each other and stored in advance in the entries 653, 651 and 652, respectively. The data rate determination table 650 in reality stores data in finer divisions in each of the entries.

For example, if the C/I value received from the signal processing section 130 is “−12.5 (dB),” the symbol determination section 120 refers to the data rate determination table 650 and specifies a C/I value “−12.5 (dB)” from one of the entries 653. The symbol determination section 120 then selects a DRC value “0×1” that is registered in one of the entries 652 and correlated to the C/I value “−12.5 (dB),” and sends this data to the signal processing section 130.

The signal processing section 130 sends data on the DRC value “0×1” to the access point 200 via the sending/receiving section 140. The access point 200 sends data to the access terminal 100 at a transmission rate “38.4 (kbps)” that corresponds to the DRC value “0×1” requested. Due to the fact that the access terminal 100 has the data rate determination table 650 in advance, the access terminal 100 can determine its requested data rate and receive data from the access point 200 at the data rate it requested.

The data rate determination table 650 in FIG. 5 assumes that an HDR system is applied to data communications. Furthermore, all subsequent descriptions assume that the HDR system is applied to data communications. However, the present embodiment is not limited to this. Any communications system with which data can be communicated wirelessly is acceptable.

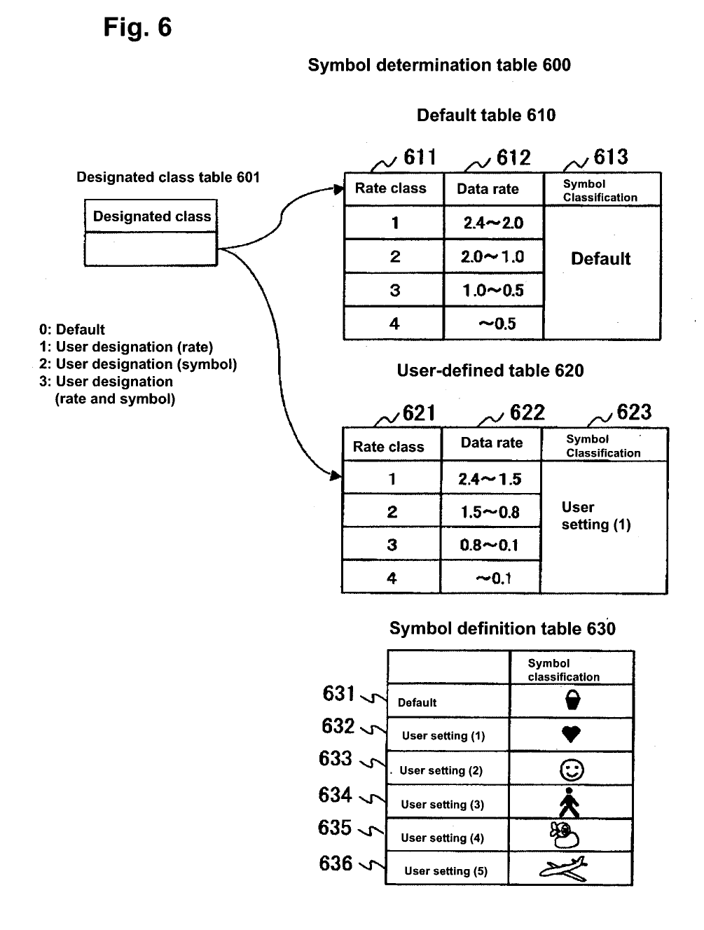

FIG. 6 is an example of a data structure of the symbol determination table 600 that is stored in the storage section 160 of each of the access terminals 100.

As FIG. 6 shows, the symbol determination table 600 has a designated class table 601, a default table 610, a user-defined table 620 and a symbol definition table 630.

Symbols that indicate various data rates to be displayed on the access terminal 100 depending on the classification of the symbol (“default,” “user setting (1),” “user setting (2),” “user setting (3),” “user setting (4),” and “user setting (5)”) (631˜636) are registered in the symbol definition table 630.

A default table 610 has entries 611 to register rate classes, entries 612 to register data rates, and entries 613 to register symbol classifications. Various data in the default table 610 are stored in advance by the provider of the access terminal 100.

The rate classes registered in the entries 611 are data rates divided into classes based on rate. In this example, there are four rate classes. However, the present invention is not limited to this and any configuration is acceptable as long as there is a plurality of rate classes. Each of the data rates that is registered in the entries 612 corresponds to (i.e., is categorized into) one of the four rate classes 611. The symbols that are registered in the entries 613 define the types of symbols that are displayed on the symbol display section 110 of each of the access terminals 100.

For example, in the default table 610 shown in FIG. 6, a data rate “2.4˜2.0 (Mbps)” is stored for a rate class “1,” a data rate “2.0˜1.0 (Mbps)” is stored for a rate class “2,” a data rate “1.0˜0.5 (Mbps)” is stored for a rate class “3,” and a data rate “˜0.5 (Mbps)” is stored for a rate class “4.” A symbol classification “default” that is stored in the symbol definition table 630 is stored under symbol classification.

The user-defined table 620, like the default table 610, has entries 621 to register rate classes, entries 622 to register data rates, and entries 623 to register symbol classifications. The user-defined table 620 is used when symbols other than symbols that represent default data rates are to be displayed on the symbol display section 110 of each of the access terminals 100.

For example, in the user-defined table 620 shown in FIG. 6, a data rate “2.4˜1.5 (Mbps)” is stored for a rate class “1,” a data rate “1.5˜0.8 (Mbps)” is stored for a rate class “2,” a data rate “0.8˜0.1 (Mbps)” is stored for a rate class “3,” and a data rate “˜0.1 (Mbps)” is stored for a rate class “4.” A symbol classification “user setting (1)” that is stored in the symbol definition table 630 is stored under symbol classification. Other symbol classifications stored in the symbol definition table 630 may also be stored in the entries 623, where a symbol classification for the user-defined table 620 is registered.

Due to the fact that a user can freely change rate class categories that correspond to display symbols for data rates, the user can have displayed symbols for rate classes of data rates that suit the tendencies of data that the user communicates. Furthermore, the user can have displayed symbols of his or her preference. The flow of processing by each of the access terminals 100 in displaying symbols related to data rates are described in detail later.

The designated class table 601 stores identifiers that designate modes of symbol displays displayed on the access terminal 100. In this example, one of an identifier for “0: default,” an identifier for “1: user designation (rate),” an identifier for “2: user designation (symbol),” and an identifier for “3: user designation (rate and symbol)” is stored in the designated class table 601.

For example, when using data registered in the default table 610 to determine both the rate class and the symbol to be used for display, “0: default” is stored in the designated class table 601. In this case, the symbol determination section 120 selects the default table 610 as a reference table to determine the rate class and the symbol, based on the designation “0: default” in the designated class table 601.

Or, for example, when using data registered in the default table 610 to determine the rate class and using data registered in the user-defined table 620 to determine the symbol to be used for displaying, “2: user designation (symbol)” is stored in the designated class table 601. In this case, the symbol determination section 120 selects the default table 610 and the user-defined table 620 as reference tables to determine the rate class and the symbol, respectively, based on the designation “2: user designation (symbol)” in the designated class table 601.

Next, the symbol determination section 120 determines symbol data, which is registered in the symbol designation table 630 and correlated to the symbol classification registered in the reference table for symbol classification, and the rate class, which corresponds to the data rate registered in the reference table for data rate.

Next, descriptions are made as to an operation by each of the access terminals 100 to display a symbol that corresponds to a data rate, in a mobile communications system according to the present embodiment.

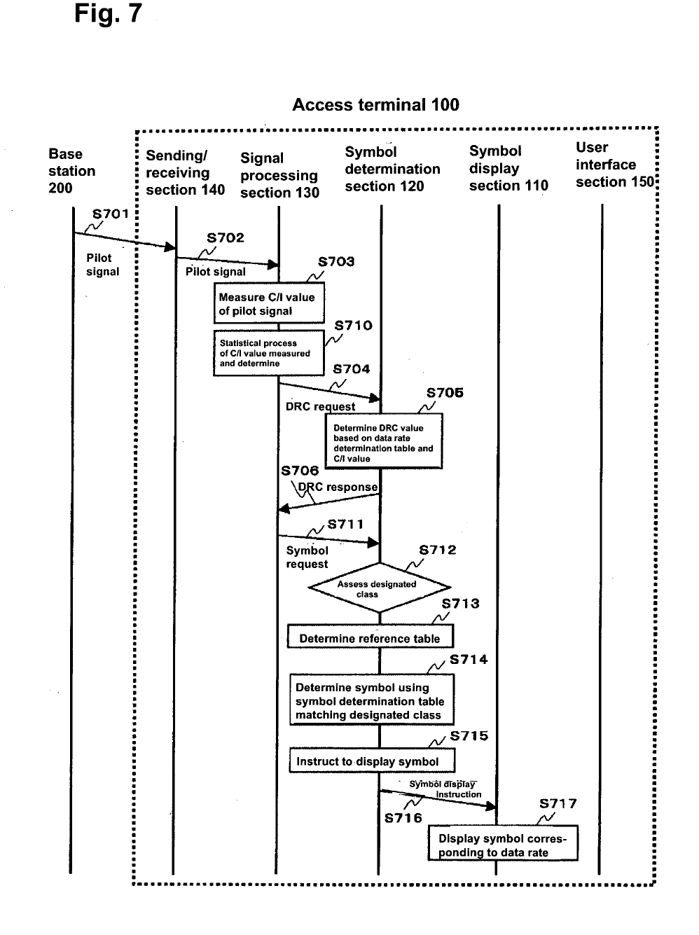

FIG. 7 illustrates a sequence of operations by the access terminal 100 for displaying a symbol corresponding to a data rate, in the mobile communications system according to the first embodiment. In FIG. 7, processing steps that are identical to the processing steps in FIG. 4 are assigned the same numbers as in FIG. 4.

First, let us consider a situation in which “0: default,” which indicates that data registered in the default table 610 are used for both the data rate and the symbol, is registered in the designated class table 601 of the storage section 160 of one of the access terminals 100.

The flow S701-S703 shown in FIG. 4 also takes place in FIG. 7. Through this, the signal processing section 130 measures C/I values of a pilot signal. The C/I values are measured 600 times per second, for example. The signal processing section 130 then performs a statistical processing of the C/I values measured and determines a C/I value, which becomes an argument of a DRC value (S710). In the present invention, the method of the statistical processing may be any method. For example, an average value of the C/I values measured may be calculated per unit time predetermined, and the average value may be used as the argument value to determine the data rate. Next, the signal processing section 130 sends the C/I value determined to the symbol determination section 120 at a predetermined timing and requests a DRC value (S704).

The symbol determination section 120 determines the DRC value based on the C/I value sent from the signal processing section 130 and on the data rate determination table 650 stored in the storage section 160 (S705). The symbol determination section 120 sends the DRC value determined to the signal processing section 130 (S706).

Upon receiving the DRC value from the symbol determination section 120, the signal processing section 130 issues a symbol request instruction to the symbol determination section 120 (S711). Thereafter, the symbol display processing is performed by the symbol determination section 120.

The symbol determination section 120 assesses the designated class based on the class defined in the designated class table 601 (S712) and determines a reference table (S713). The default table 610 is selected as the reference table in this case, since “0: default” is set as the designated class.

For example, if the data rate value that corresponds to the DRC value determined is “1.5 Mbps,” the rate class “2” is determined based on the data rate value of “1.5 Mbps” and on the default table 610. In addition, the symbol to be displayed is determined based on the symbol classification “default” in the default table 610 and the symbol definition table 630.

The symbol determination section 120 instructs the symbol display section 110 to display the symbol determined in a display mode that corresponds to the rate class determined (S715 and S716). The symbol display section 110 displays the symbol according to the instruction (S717).

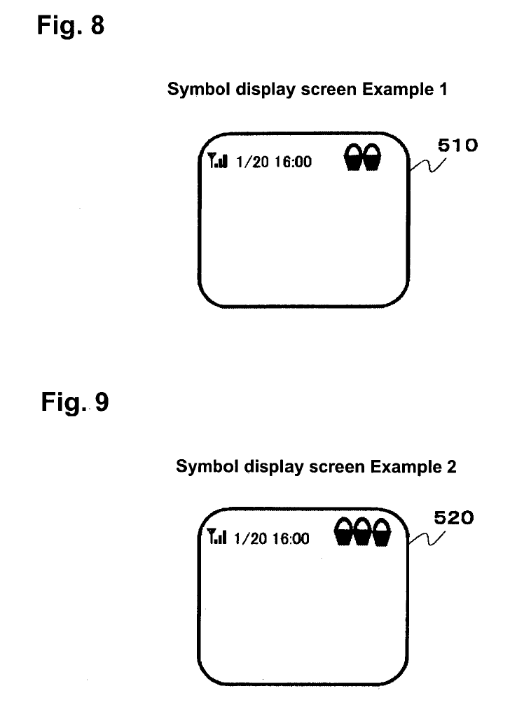

FIG. 8 is an example of a symbol display screen displayed by the symbol display section 110. In this case, when the rate class is “1,” three symbols are displayed; when the rate class is “2,” two symbols are displayed; when the rate class is “3,” one symbol is displayed; and when the rate class is “4,” no symbols are displayed. For example, if the symbol display section 110 receives an instruction to display “rate class: 2, symbol: default” from the symbol determination section 120, two symbols in a “bucket” design that corresponds to the symbol classification “default” are displayed, as shown in a display screen 510.

Next, we will use FIG. 7 to describe a situation in which “1: user designation (rate),” which indicates that data registered in the user-defined table 620 is used for the data rate and data registered in the default table 610 is used for the symbol, is registered in the designated class table 601 of the storage section 160 in one of the access terminals 100.

In FIG. 7, the processing up to the point at which the signal processing section 130 issues a symbol request instruction to the symbol determination section 120 is the same as in the situation in which “0: default” is registered in the designated class table 601 (S701˜S711). In the present case, we will assume that the data rate value that corresponds to the DRC value determined by the symbol determination section 120 is “1.5 Mbps.”

The symbol determination section 120 assesses the designated class based on the class defined in the designated class table 601 (S712) and determines the reference tables (S713). The user-defined table 620 is selected as a reference table to determine the rate class and the default table 610 is selected as a reference table to determine the symbol to be displayed, since “1: user designation (rate)” is set as the designated class in this case.

The symbol determination section 120 determines the rate class based on the relations between rate classes and data rates in the user-defined table 620. In addition, the symbol determination section 120 determines from the symbol definition table 630 the symbol to be displayed based on the symbol classification “default” in the default table 610 (S714).

In this case, since the data rate that corresponds to the DRC value is “1.5 Mbps,” the symbol determination section 120 selects the rate class “1” that corresponds to the data rate “1.5 Mbps” in the user-defined table 620 in FIG. 6 and determines from the symbol definition tables 630 the symbol that corresponds to the symbol classification “default” in the default table 610.

Next, the symbol determination section 120 instructs the symbol display section 110 to display the symbol determined in a display mode that corresponds to the rate class determined (S715 and S716). The symbol display section 110 displays the symbol according to the instruction (S717).

FIG. 9 is an example of a symbol display screen displayed by the symbol display section 110. In this case, since the user-defined table 620 is applicable to determine the rate class, the rate class “1” is selected as the rate class that corresponds to the data rate “1.5 Mbps” (if the default table 610 were applicable, the rate class would be “2”). As a result, the symbol display section 110 displays three symbols in a “bucket” design that corresponds to the symbol classification “default,” as shown in a display screen 520.

Next, we will use FIG. 7 to describe a situation in which “2: user designation (symbol),” which indicates that data registered in the default table 610 is used for the data rate and data registered in the user-defined table 620 is used for the symbol, is registered in the designated class table 601 of the storage section 160 in one of the access terminals 100.

In FIG. 7, the processing up to the point at which the signal processing section 130 issues a symbol request instruction to the symbol determination section 120 is the same as in the situation in which “0: default” is registered in the designated class table 601 (S701-S711). In the present case, we will assume that the data rate value that corresponds to the DRC value determined by the symbol determination section 120 is “1.5 Mbps.”

The symbol determination section 120 assesses the designated class based on the class defined in the designated class table 601 (S712) and determines the reference tables (S713). The default table 610 is selected as a reference table to determine the rate class and the user-defined table 620 is selected as a reference table to determine the symbol to be displayed, since “2: user designation (symbol)” is set as the designated class in this case.

The symbol determination section 120 determines the rate class based on the relations between rate classes and data rates in the default table 610. In addition, the symbol determination section 120 determines from the symbol definition table 630 the symbol to be displayed based on the symbol classification “user setting (1)” in the user-defined table 620 (S714).

In this case, since the data rate that corresponds to the DRC value is “1.5 Mbps,” the symbol determination section 120 selects the rate class “2” that corresponds to the data rate “1.5 Mbps” in the default table 610 in FIG. 6 and determines from the symbol definition table 630 the symbol that corresponds to the symbol classification “user setting (1)” in the user-defined table 620.

Next, the symbol determination section 120 instructs the symbol display section 110 to display the symbol determined in a display mode that corresponds to the rate class determined (S715 and S716). The symbol display section 110 displays the symbol according to the instruction (S717).

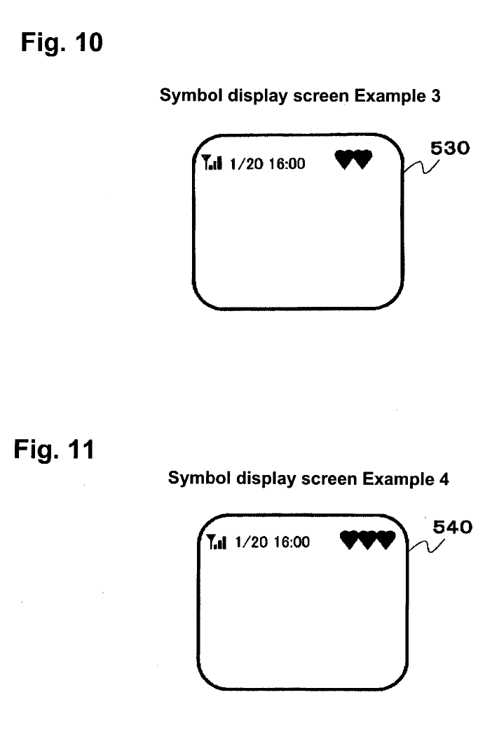

FIG. 10 is an example of a symbol display screen displayed by the symbol display section 110. In this case, since the default table 610 is applicable to determine the rate class, the rate class “2” is selected as the rate class that corresponds to the data rate “1.5 Mbps.” As a result, the symbol display section 110 displays two symbols in a “heart” design that corresponds to the symbol classification “user setting (1),” as shown in a display screen 530.

Next, we will use FIG. 7 to describe a situation in which “3: user designation (rate and symbol),” which indicates that data registered in the user-defined table 620 are used for both the data rate and the symbol, is registered in the designated class table 601 of the storage section 160 in one of the access terminals 100.

In FIG. 7, the processing up to the point at which the signal processing section 130 issues a symbol request instruction to the symbol determination section 120 is the same as in the situation in which “0: default” is registered in the designated class table 601 (S701˜S711). In the present case, we will assume that the data rate value that corresponds to the DRC value determined by the symbol determination section 120 is “1.5 Mbps.”

The symbol determination section 120 assesses the designated class based on the class defined in the designated class table 601 (S712) and determines the reference table (S713). The user-defined table 620 is selected as the reference table, since “3: user designation (rate and symbol)” is set as the designated class in this case.

The symbol determination section 120 determines the rate class based on the relations between rate classes and data rates in the user-defined table 620. In addition, the symbol determination section 120 determines from the symbol definition table 630 the symbol to be displayed based on the symbol classification “user setting (1)” in the user-defined table 620 (S714).

In this case, since the data rate that corresponds to the DRC value is “1.5 Mbps,” the symbol determination section 120 selects the rate class “1” that corresponds to the data rate “1.5 Mbps” in the user-defined table 620 in FIG. 6 and determines from the symbol definition table 630 the symbol that corresponds to the symbol classification “user setting (1)” in the user-defined table 620.

Next, the symbol determination section 120 instructs the symbol display section 110 to display the symbol determined in a display mode that corresponds to the rate class determined (S715 and S716). The symbol display section 110 displays the symbol according to the instruction (S717).

FIG. 11 is an example of a symbol display screen displayed by the symbol display section 110. In this case, since the user-defined table 620 is applicable to determine the rate class, the rate class “1” is selected as the rate class that corresponds to the data rate “1.5 Mbps.” As a result, the symbol display section 110 displays three symbols in a “heart” design that corresponds to the symbol classification “user setting (1),” as shown in a display screen 540.

Next, we will describe operations by the access terminal 100 to register and update the symbol definition table 630 and the user-defined table 620, in the mobile communications system according to the present embodiment.

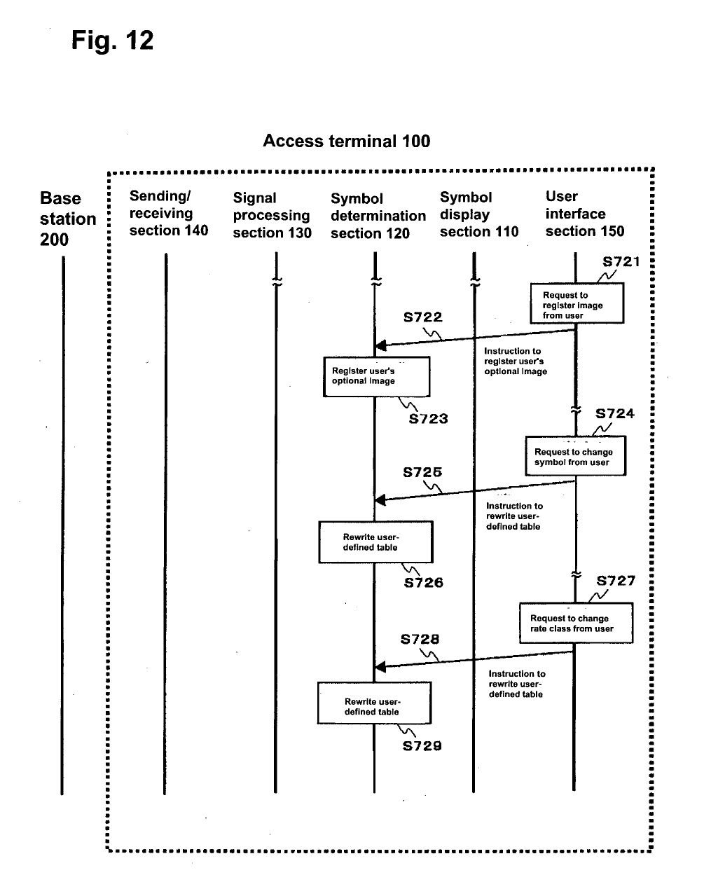

FIG. 12 illustrates the sequence involved in the operations by the access terminal 100 to register and update the symbol definition table 630 and the user-defined table 620, in the mobile communications system according to the first embodiment.

In the terminal 100, the user interface section 150 displays on the symbol display section 110 an interface screen (omitted from drawings) used to register and update symbol data in the symbol definition table 630, and receives from a user image data of the user's choice as symbol data, along with symbol classifications (S721). The method with which the user interface section 150 accepts image data of the user's choice from the user may be any method. For example, the access terminal 100 may download via the sending/receiving section 140 image symbol data provided by websites on the Internet and have the user interface section 150 accept the image data.

The user interface section 150 sends the image data accepted to the symbol determination section 120 and instructs the symbol determination section 120 to register the images accepted from the user (S722). Upon receiving the instruction from the user interface section 150, the symbol determination section 120 stores in the symbol definition table 630 stored in the storage section 160 the image data accepted with correlation to the symbol classifications accepted (S723).

Further, in order to accept a change to a symbol classification displayed on the symbol display section 110, the user interface section 150 displays on the symbol display section 110 an interface screen (omitted from drawings) to be used to change symbol classifications, and accepts a request to change the symbol classification from the user (S724).

The user interface section 150 sends to the symbol determination section 120 the data on the accepted request to change symbol classifications (S725). The symbol determination section 120 updates data in the designated class table 601 and data in the symbol classifications 623 of the user-defined table 620, both of which are stored in the storage section 160, based on the data on the request to change symbol classifications from the user interface section 150 (S726).

For example, when the symbol determination table 600 is entirely in default setting, let us assume that the user interface section 150 receives a request to change the symbol classification to be displayed to the symbol in the user setting (1) 632 stored in the symbol definition table 630. In such a situation, the symbol determination section 120, upon receiving data on the request to change symbols from the user interface section 150, changes data in the designated class table 601 from “0: default” to “2: user designation (symbol)” and stores “user setting (1)” in the symbol classification 623 of the user-defined table 620.

Moreover, the user interface section 150 displays on the symbol display section 110 an interface screen (omitted from drawings) used to change rate class categories in the symbol determination table 600, and accepts a change to the rate class category from the user (S727).

The user interface section 150 sends to the symbol determination section 120 data on an accepted request to change the rate class category (S728). The symbol determination section 120 changes data in the designated class table 601 and data in the data rate 622 of the user-defined table 620, both of which are stored in the storage section 160, based on the data on the request to change the rate class category from the user interface section 150 (S729).

As described above, according to the first embodiment of the present invention, due to the fact that a data rate is categorized into the rate class it belongs to and displayed on the symbol display section 110 of each of the access terminals 100 as a symbol, the user can communicate the data after determining the time and cost required for the data communication.

Further according to the first embodiment of the present invention, due to the fact that the user can freely set rate classes corresponding to data rates represented as symbols displayed on each of the access terminals 100, a data rate appropriate for the communication data that the user uses can be displayed on the access terminal 100. By displaying the data rate appropriate for the communication data used by the user, the user can choose not to communicate data when the data rate is slow in relation to the communication data on example. This can lead to improved line efficiency of the network and to improved service provided by communications carriers to the users of the access terminals 100.

Moreover according to the first embodiment of the present invention, due to the fact that the user can set symbol classifications displayed for various data rates on each of the access terminals 100 according to his or her preferences, the user's level of satisfaction can be improved.

Next, a second embodiment of the present invention will be described.

In the second embodiment of the present invention, a statistical processing is performed on a C/I value determined in each access terminal 100, and symbols displayed are changed based on data from the statistical processing.

An overall general configuration of a mobile communications system of the second embodiment of the present invention is identical to that of the mobile communications system in the first embodiment of the present invention shown in FIG. 1. Additionally, the configuration of functions of an access point 200 in the second embodiment is identical to the configuration of functions of the access point 200 in the first embodiment of the present invention shown in FIG. 3.

The configuration of functions of each access terminal 100 is substantially the same as that of the first embodiment of the present invention shown in FIG. 2, except a part of the processing performed by a symbol determination section 120 that is different. In the description of the second embodiment, components that are the same as those of the first embodiment are assigned the same numbers.

First, descriptions are made as to an operation by each of the access terminals 100 to display a symbol that corresponds to a data rate, in the mobile communications system according to the second embodiment of the present invention.

FIG. 3 illustrates the sequence of operations by each of the access terminals 100 for displaying a symbol corresponding to a data rate, in the mobile communications system according to the second embodiment.

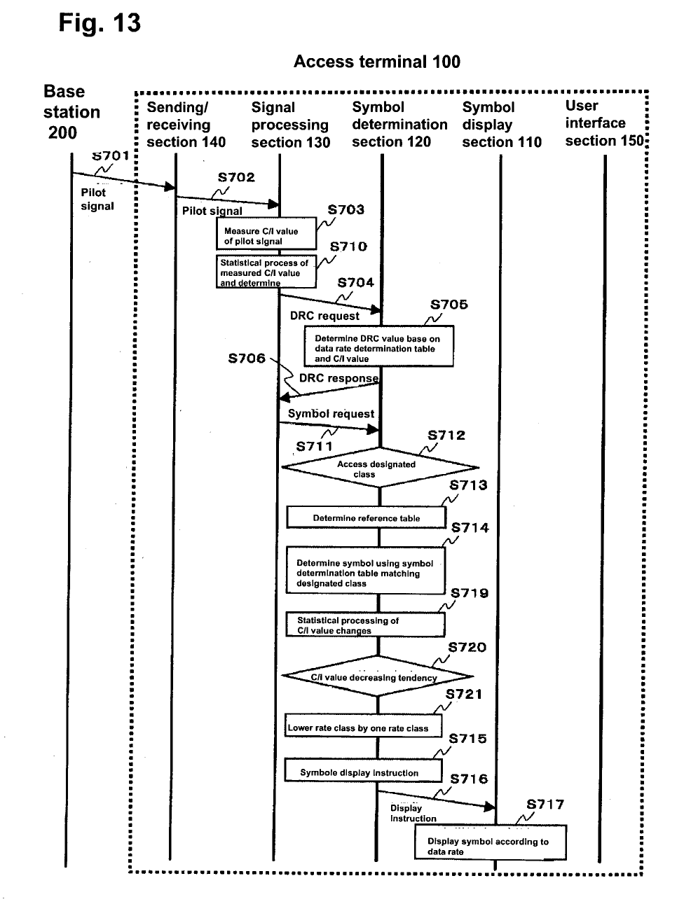

In FIG. 13, processing steps that are identical to the processing steps in FIG. 7 are assigned the same numbers as in FIG. 7.

The processing is identical to the first embodiment in FIG. 7 up to the point at which the symbol determination section 120 determines the applicable symbol (S701-S714).

After determining the symbol, the symbol determination section 120 performs a statistical processing at any interval on C/I values that serve as a basis for determining a DRC value (S719). In the statistical processing, an increase/decrease tendency value of the C/I values per predetermined unit time is found. The method of statistical processing may be any method. Any method with which the increase/decrease tendency value of the C/I values per predetermined unit time can be found may be used.

If the increase/decrease tendency value of the C/I values as a result of the statistical processing shows greater decrease tendency than a predetermined value (S720), the symbol determination section 120 lowers the rate class to be displayed by one class from the current rate class (S721) and instructs this to a symbol display section 110 (S715 and S716).

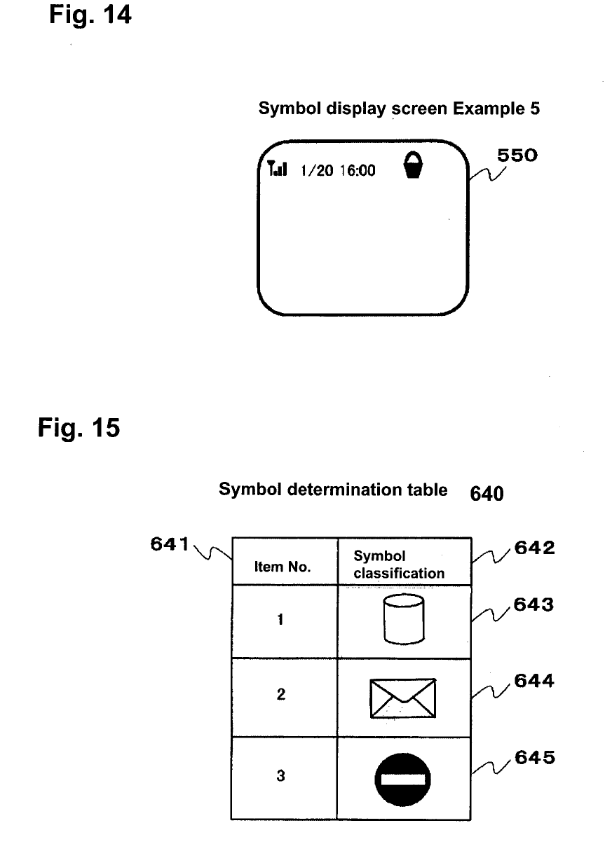

For example, let us assume that a symbol determination table 600 of one of the access terminals 100 is entirely in default setting and that a data rate that corresponds to a DRC value as an argument of symbol display is “1.5 Mbps.” If in this situation the symbol determination section 120 decides to lower the rate class based on the statistical processing (S719-S721), the rate class specified based on a default table 610 and on the data rate “1.5 Mbps” is lowered by one class from “2” to “3.” As a result, the symbol displayed on the symbol display section 110 is one symbol of a “bucket,” as shown in a symbol display screen 550 in FIG. 14 (if the decision to lower the rate class is not made, two symbols would be displayed as in the symbol display screen 510 in FIG. 8).

As described above, a symbol for a rate class corresponding to a data rate that takes into consideration a changing tendency in the data rate is displayed according to the second embodiment of the present invention. Consequently, adequate information can be provided to a user to determine whether the user, who receives particularly large capacity data that would require a long period of time, should receive the data, thereby improving the user's level of satisfaction.

Next, descriptions will be made as to a third embodiment of the present invention. In the third embodiment of the present invention, instead of having each access terminal 100 determine a symbol display that corresponds to a data rate, an access point 200 determines a data rate and the access terminal 100 displays a symbol that corresponds to the data rate determined.

An overall general structure of the mobile communications system in accordance with the third embodiment of the present invention is substantially the same as that of the mobile communications system of the first embodiment according to the present invention shown in FIG. 1.

The configuration of functions of the access point 200 is generally the same as the configuration of functions of the access point 200 in the first embodiment shown in FIG. 3, except parts of the processing performed by a control section 230 and a statistical processing section 240 that are different. The control section 230 of the access point 200 causes a communication processing section 220 to send a pilot signal. In addition, the control section 230 determines a data rate of data communication to the access terminals 100. Furthermore, the control section 230 includes a flag that indicates the data rate determined in the pilot signal that is sent by the communication processing section 220. The flag that indicates the data rate is correlated to data in a symbol determination table stored in a storage section 160 of the access terminal 100.

The method for determining the data rate as performed by the control section 230 is not limited in any particular way according to the third embodiment of the present invention. For example, the statistical processing section 240 can perform any statistical processing on data on requested data rate from the access terminal 100 as measured by a measuring section 210, and the data rate can be determined based on the result of the statistical processing. Alternatively, the control section 230 can determine the data rate when the access point 200 wishes to restrain or rouse use by the users due to traffic conditions on the network or other reasons on the part of the access point 200. Or, a communications carrier can provide a plurality of types of communications services to the users, and the access point 200 may determine a data rate that corresponds to a communications contract with each of the users.

The configuration of functions of each access terminal 100 of the third embodiment is generally the same as in the first embodiment of the present invention shown in FIG. 2, except a part of the processing performed by a signal processing section 130 and a part of the processing performed by a symbol determination section 120 that are different. In the description of the third embodiment, elements that are the same as the first embodiment are assigned the same numbers.

Next, descriptions are made as to a symbol determination table stored in the storage section 160 of the access terminal 100. FIG. 15 is an example of a data structure of a symbol determination table 640 according to the third embodiment of the present invention.

As FIG. 15 shows, the symbol determination table 640 has entries 641 to register item numbers and entries 642 to register symbol classifications. Various data in the symbol determination table 640 are stored in advance by the provider of the access terminal 100. For example, symbols that represent data rates that are to be displayed on the access terminal 100 are stored in the symbol determination table 640 correlated to various item numbers (“1,” “2,” and “3”). In the entries 642 used to register symbol classifications according to the present embodiment, “a symbol 643 representing a data rate optimal for the communication of large capacity data,” “a symbol 644 representing a data rate optimal for electronic mail communication,” and “a symbol 645 representing an extremely slow data rate” are stored.

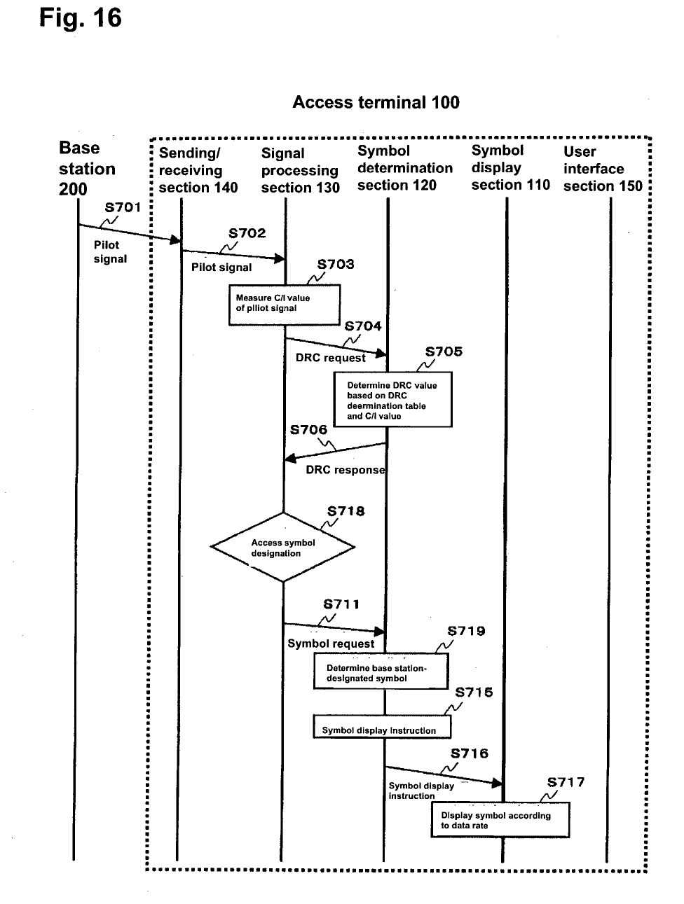

FIG. 16 illustrates the sequence of operations by each of the access terminals 100 for displaying a symbol corresponding to a data rate, in the mobile communications system according to the third embodiment.

In FIG. 16, processing steps that are identical to the processing steps in FIG. 7 are assigned the same numbers as in FIG. 7.

The communication processing section 220 of the access point 200 sends a pilot signal (S701). As described above, the flag data that indicates a data rate correlated to data stored in the symbol determination table 640 of the access terminal 100 is included in a location of one's choice in the pilot signal.

A processing performed by the symbol determination section 120 of the access terminal 100 to respond to the signal processing section 130 with a DRC value is the same as in the first embodiment shown in FIG. 7 (S702-S706). In addition to these processing steps, the signal processing section 130 reads the flag data that is included in the pilot signal and correlated to data stored in the symbol determination table 640 (S718), sends the flag data to the symbol determination section 120, and issues a symbol request instruction (S711).

Upon receiving the symbol request instruction, the symbol determination section 120 determines a symbol based on the flag data and on data in the symbol determination table 640 (S719) and instructs a symbol display section 110 to display the symbol (S716). The symbol display section 110 displays the symbol based on the data rate, according to the instruction from the symbol determination section 120 (S717).

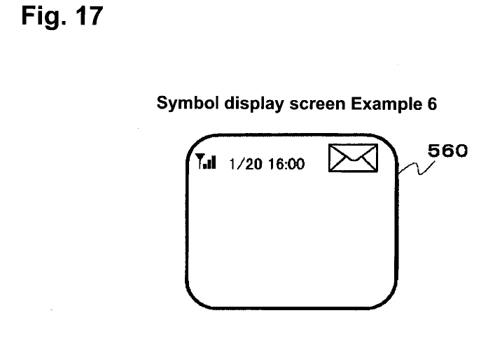

FIG. 17 is an example of a symbol display screen of the access terminal 100 according to the third embodiment of the present invention. In the present example, a flag data that indicates “a data rate optimal for electronic mail communication” is included in a pilot signal sent by the access point 200. The symbol determination section 120 determines the symbol to be displayed based on the flag data and on the symbol determination table 640 shown in FIG. 15, and causes the symbol display section 110 to display the symbol of a design for “a letter 644 representing a data rate optimal for electronic mail communication,” as shown in a symbol display screen 560.

As described above, according to the third embodiment of the present invention, a data rate determined by the access point 200 can be displayed on the access terminal 100 as a symbol representing the data rate. Consequently, by having the access point 200 determine a data rate that takes into consideration the network traffic and by displaying the data rate on the access terminal 100, for example, the user can be restrained or roused to communicate data.

Next, a fourth embodiment of the present invention will be described. In the fourth embodiment, instead of displaying rate classes of data rates by indicating different classes by the number of symbols as in the first embodiment, rate classes of data rates are displayed by different symbol classifications.

The fourth embodiment of the present invention is generally the same as the first embodiment of the present invention, except a data structure of a symbol determination table stored in a storage section 160 of each access terminal 100 that is different. In the description of the fourth embodiment, elements that are identical to the first embodiment are assigned the same numbers.

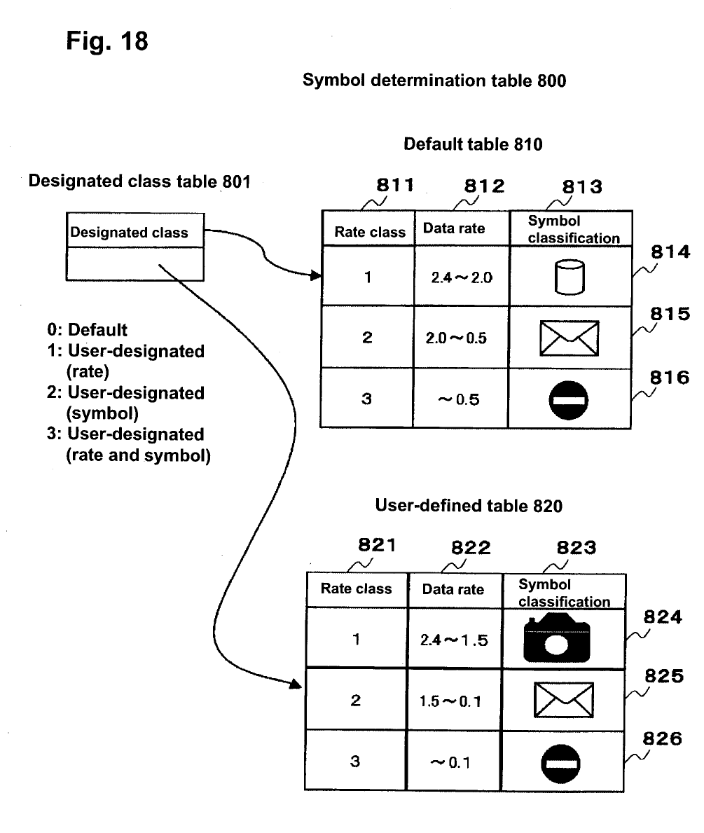

FIG. 18 is an example of a data structure of a symbol determination table 800 stored in the storage section 160 of each access terminal 100 according to the fourth embodiment of the present invention.

As FIG. 18 shows, the symbol determination table 800 has a designated class table 801, a default table 810 and a user-defined table 820.

The default table 810 has entries 811 to register rate classes, entries 812 to register data rates, and entries 813 to register symbol classifications. Various data in the default table 610 are stored in advance by the provider of the access terminal 100. The rate classes registered in the entries 811 are data rates divided into classes based on rate. In this example, there are three rate classes, but the present invention is not limited to this and any configuration is acceptable as long as there is a plurality of rate classes. Each of the data rates that is registered in the entries 812 corresponds to (i.e., is categorized into) one of the three rate classes 811. The symbols that are registered in the entries 813 define the types of symbols that are displayed on a symbol display section 110 of each of the access terminals 100.

For example, in the default table 810 shown in FIG. 18, for a rate class “1,” a data rate “2.4˜2.0 (Mbps)” and a symbol classification “symbol 814 representing a data rate optimal for the communication of large capacity data” are stored. For a rate class “2,” a data rate “2.0˜0.5 (Mbps)” and a symbol classification “symbol 815 representing a data rate optimal for electronic mail communication” are stored. For a rate class “3,” a data rate “˜0.5 (Mbps)” and a symbol classification “symbol 816 representing an extremely slow data rate” are stored.

The user-defined table 820, like the default table 810, has entries 821 to register rate classes, entries 822 to register data rates, and entries 823 to register symbol classifications. The user-defined table 820 is used when symbols other than symbols that represent default data rates are to be displayed on the symbol display section 110 of each of the access terminals 100.

For example, in the user-defined table 820 shown in FIG. 18, for “1” under the rate class 821, “2.4˜1.5 (Mbps)” is stored under the data rate 822 and a “symbol 824 for a camera (photograph) representing a rate class optimal for image data communication” is stored under the symbol classification 823. For “2” under the rate class 821, “1.5˜0.1 (Mbps)” is stored under the data rate 822 and a “symbol 825 for mail (letter)” is stored under the symbol classification 823. For “3” under the rate class 821, “˜0.1 (Mbps)” is stored under the data rate 822 and a “symbol 826 representing an extremely slow data rate” is stored under the symbol classification 823.

The data structure of the designated class table 801 is identical to that of the designated class table 601 in the first embodiment.

Next, referring to FIGS. 7 and 18, descriptions are made as to an operation by each of the access terminals 100 for displaying a symbol corresponding to a data rate, in the mobile communications system according to the fourth embodiment of the present invention. In the present embodiment, we assume that the symbol determination table 800 is entirely in default setting and that the data rate that corresponds to a DRC value as an argument of a symbol display used by a symbol determination section 120 is “1.5 Mbps.”

The operation in the forth embodiment is identical to the first embodiment up to the point at which the symbol determination section 120 assesses the designated class (S701-S712). The symbol determination section 120 selects the default table 810 as a reference table (S713). In addition, the symbol determination section 120 determines a symbol to be displayed based on the default table 810 and on the data rate “1.5 Mbps” that corresponds to the DRC value as the argument of the symbol display (S714), and instructs the symbol display section 110 to display the symbol (S715 and S716).

In the present example, the symbol for “letter (mail)” for the rate class “2”0 that corresponds to the data rate “1.5 Mbps” is displayed on the symbol display section 110, as shown in FIG. 17 (S717). If a user sets the data rate and the display symbol, the symbol determination section 120 chooses the user-defined table 820 as a reference table (S713).

As described above, according to the fourth embodiment of the present invention, due to the fact that a symbol display for a rate class that corresponds to a data rate is based on different symbol types in the access terminal 100, a user can ascertain the optimal data rate for communication with a glance of the symbol classification. Further according to the fourth embodiment of the present invention, due to the fact that the user can freely set rate class categories for various data rates that correspond to various symbols displayed on the access terminal 100 and can display the appropriate rate as a symbol classification, a data rate appropriate for communication data used by the user can be displayed on the access terminal 100.

The present invention is not limited to the embodiments described above and many modifications can be made without departing from the present invention. For example, instead of having the switching station 300 connected to the access point 200 as shown in FIG. 1, the access point 200 can be directly connected to other networks.

As described above, according to the present invention, symbols correlated to data rates suited for various types of users' communication data can be displayed in a mobile communications system. Further according to the present invention, symbols correlated to data rates determined by an access point can be displayed.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A mobile terminal that performs mobile communications via a base station, comprising:
a receiving section that receives a signal from the base station to measure a data rate;
a signal processing section that measures data relating to the data rate based on the signal received by the receiving section;
a symbol determination section that, according to predetermined rules, specifies a data rate based on the data measured by the signal processing section, categorizes the specified data rate into a rate class, and specifies an image symbol that is determined in advance to correspond to the categorized rate class; and
a display section that displays the image symbol specified by the symbol determination section.

2. A mobile terminal according to claim 1, further comprising a storage section that stores a symbol determination table that stores rate classes, data rate ranges, and image symbols that are correlated to each other in advance, wherein the symbol determination section categorizes the specified data rate into the rate class to which the specified data rate belongs based on data stored in the symbol determination table and specifies an image symbol corresponding to the categorized rate class.

3. A mobile terminal according to claim 2, further comprising a user interface section that accepts registration of, and changes to, the rate classes in the symbol determination table, as well as registration of, and changes to, the image symbols in the symbol determination table.

4. A mobile terminal according to any one of claims 1-3, wherein the symbol determination section performs a statistical processing to find an increase/decrease tendency value in data regarding the data rate measured by the signal processing section, and if the increase/decrease tendency value obtained through the statistical processing indicates a greater decrease tendency than a predetermined value, an image symbol that corresponds to a rate class one class lower than the image symbol that corresponds to the specified rate is newly specified, and the newly specified image symbol is displayed on the display section.

5. A mobile communications system comprising:
at least one mobile terminal including a receiving section that receives a signal from the base station to measure a data rate, a signal processing section that measures data relating to the data rate based on the signal received by the receiving section, a symbol determination section that, according to predetermined rules, specifies a data rate based on the data measured by the signal processing section, categorizes the specified data rate into a rate class, and specifies an image symbol that is determined in advance to correspond to the categorized rate class, and a display section that displays the image symbol specified by the symbol determination section; and
a base station that is connectable to the mobile terminal via a wireless network, the base station having a communication processing section that sends to the mobile terminal a signal for measuring the data rate.

6. A mobile communications system according to claim 5, wherein the mobile terminal further comprises a storage section that stores a symbol determination table that stores rate classes, data rate ranges, and image symbols that are correlated to each other in advance, wherein the symbol determination section categorizes the specified data rate into the rate class to which the specified data rate belongs based on data stored in the symbol determination table and specifies an image symbol corresponding to the categorized rate class.

7. A mobile communications system according to claim 6, wherein the mobile terminal further comprises a user interface section that accepts registration of, and changes to, the rate classes in the symbol determination table, as well as registration of, and changes to, the image symbols in the symbol determination table.

8. A mobile terminal according to any one of claims 5-7, wherein the symbol determination section performs a statistical processing to find an increase/decrease tendency value in data regarding the data rate measured by the signal processing section, and if the increase/decrease tendency value obtained through the statistical processing indicates a greater decrease tendency than a predetermined value, an image symbol that corresponds to a rate class one class lower than the image symbol that corresponds to the specified rate is newly specified, and the newly specified image symbol is displayed on the display section.

9. A mobile terminal that performs mobile communications via a base station comprising:
a receiving section that receives from the base station a signal that includes data that designates a data rate;
a symbol determination section that specifies, according to predetermined rules, an image symbol that corresponds to the data rate based on the data that designates the data rate and that is included in the signal received by the receiving section; and
a display section that displays the image symbol specified by the symbol determination section.

10. A mobile communications system comprising:
at least one mobile terminal including a receiving section that receives from the base station a signal that includes data that designates a data rate;
a symbol determination section that specifies, according to predetermined rules, an image symbol that corresponds to the data rate based on the data that designates the data rate and that is included in the signal received by the receiving section; and
a display section that displays the image symbol specified by the symbol determination section; and
a base station that is connectable to the mobile terminal via a wireless network, the base station having a communication processing section that sends to the mobile terminal a signal for designating the data rate.

11. A mobile communications system according to claim 10, wherein the mobile terminal further comprises a storage section that stores a symbol determination table that stores rate classes, data rate ranges, and image symbols that are correlated to each other in advance, wherein the symbol determination section categorizes the specified data rate into the rate class to which the specified data rate belongs based on data stored in the symbol determination table and specifies an image symbol corresponding to the categorized rate class.

12. A mobile communications system according to claim 11, wherein the mobile terminal further comprises a user interface section that accepts registration of, and changes to, the rate classes in the symbol determination table, as well as registration of, and changes to, the image symbols in the symbol determination table.

13. A mobile terminal according to any one of claims 10-12, wherein the symbol determination section performs a statistical processing to find an increase/decrease tendency value in data regarding the data rate measured by the signal processing section, and if the increase/decrease tendency value obtained through the statistical processing indicates a greater decrease tendency than a predetermined value, an image symbol that corresponds to a rate class one class lower than the image symbol that corresponds to the specified rate is newly specified, and the newly specified image symbol is displayed on the display section.

14. A data rate display method for displaying a data rate of communicated data on a display screen of a mobile terminal that performs mobile communications via a base station, the data rate display method comprising the steps of:
at the base station, executing a transmission processing that transmits a signal to measure a data rate; and
at the mobile terminal, executing a receiving processing that receives the signal from the base station to measure a data rate;
executing a signal processing that measures data relating to the data rate based on the signal received by the receiving processing;
executing a symbol determination processing that, according to predetermined rules, specifies a data rate based on the data measured by the signal processing section, categorizes the specified data rate into a rate class, and specifies an image symbol that is determined in advance to correspond to the categorized rate class; and
executing a display processing that displays the image symbol specified by the symbol determination section.

15. A data rate display method according to claim 14, further comprising the step of storing in a storage section a symbol determination table that stores rate classes, data rate ranges, and image symbols that are correlated to each other in advance, wherein the symbol determination processing categorizes the specified data rate into the rate class to which the specified data rate belongs based on data stored in the symbol determination table and specifies an image symbol corresponding to the categorized rate class.

16. A data rate display method according to claim 15, further comprising the step of a user interface processing that accepts registration of, and changes to, the rate classes in the symbol determination table, as well as registration of, and changes to, the image symbols in the symbol determination table.

17. A data rate display method according to any one of claims 14-16, wherein the symbol determination processing comprises the steps of:
performing a statistical processing to find an increase/decrease tendency value in data regarding the data rate measured by the signal processing section;
if the increase/decrease tendency value obtained through the statistical processing indicates a greater decrease tendency than a predetermined value, newly specifying an image symbol that corresponds to a rate class one class lower than the image symbol that corresponds to the specified rate; and displaying the newly specified image symbol on the display section.

18. A data rate display method for displaying a data rate of communicated data on a display screen of a mobile terminal that performs mobile communications via a base station, the data rate display method comprising the steps of:
at the base station, executing a transmission processing that transmits a signal including data to designate a data rate; and
at the mobile terminal, executing a receiving processing that receives from the base station a signal that includes data that designates a data rate;
executing a symbol determination processing that specifies, according to predetermined rules, an image symbol that corresponds to the data rate based on the data that designates the data rate included in the signal received by the receiving processing; and
executing a display processing that displays the image symbol specified by the symbol determination section.

19. A data rate display method according to claim- 18, further comprising the step of storing in a storage section a symbol determination table that stores rate classes, data rate ranges, and image symbols that are correlated to each other in advance, wherein the symbol determination processing categorizes the specified data rate into the rate class to which the specified data rate belongs based on data stored in the symbol determination table and specifies an image symbol corresponding to the categorized rate class.

20. A data rate display method according to claim 19, further comprising the step of a user interface processing that accepts registration of, and changes to, the rate classes in the symbol determination table, as well as registration of, and changes to, the image symbols in the symbol determination table.

21. A data rate display method according to any one of claims 18-20, wherein the symbol determination processing comprises the steps of:
performing a statistical processing to find an increase/decrease tendency value in data regarding the data rate measured by the signal processing section;
if the increase/decrease tendency value obtained through the statistical processing indicates a greater decrease tendency than a predetermined value, newly specifying an image symbol that corresponds to a rate class one class lower than the image symbol that corresponds to the specified rate; and
displaying the newly specified image symbol on the display section.
